(19) United States
(12) Patent Application Publication
(10) Pub. No.: US 2005/0038826 A1
(43) Pub. Date: Feb. 17, 2005

(54) Method of managing multimedia content written in SMIL and file system thereof

(75) Inventors: Dae-gyu Bae, Suwon-si (KR); Jin-woo Hong, Seoul (KR); Hyun-ah Sung, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/799,933

(22) Filed: Mar. 15, 2004

(30) Foreign Application Priority Data
Mar. 13, 2003 (KR) 2003-15692

(51) Int. Cl. G06F 17/00

(52) U.S. Cl. 707/200

(57) ABSTRACT

A method of managing multimedia content created using synchronous multimedia integration language (SMIL) and a file system thereof are provided. The method involves (a) extracting information on at least one resource file by parsing an SMIL document; and (b) packaging the SMIL document and the at least one resource file into a single file using the extracted information.

This application claims the priority of Korean Patent Application No. 2003-15692, filed on Mar. 13, 2003, in the Korean Intellectual Property Office, the disclosure of which is incorporated herein in its entirety by reference.

### BACKGROUND OF THE INVENTION

1. Field of the Invention

Apparatuses and methods consistent with the present invention relate to synchronized multimedia integration language (SMIL) documents, and more particularly, to a method of managing multimedia content written in SMIL and a file system thereof.

2. Description of the Related Art

Synchronized multimedia integration language (SMIL) is an international standard multimedia development language for multimedia presentations, which was suggested on Jun. 15, 1998, by the Multimedia Working Group of the World Wide Web Consortium. By using SMIL, a user can integrate a variety of independent media objects, such as sounds and moving images, into a single synchronized multimedia content and can also freely adjust the reproduction time of each media object, layouts on a screen, and screen division. For example, SMIL enables a user to adjust reproduction time of several movie titles, still images, or sounds, which have been transmitted independently. Accordingly, SMIL has been widely used in a variety of fields, such as multimedia advertising, Internet broadcasting, electronic catalogues, and educational content.

In the multimedia content written in SMIL, however, an SMIL document and media objects are contained in different files. Therefore, it is troublesome for a user to transmit the multimedia content written in SMIL because the user actually needs to separately transmit a plurality of files in the multimedia content. For example, the following SMIL document is linked to media objects, i.e., 100 picture files, img1.jpg, img2.jpg, . . . , img100.jpg.

<smil>
...
<body>
<img src=“img1.jpg” .... />
<img src=“img2.jpg” .... />
....
<img src=“img100.jpg” .... />
</body>
</smil>

As described above, the media objects are contained in different files from the SMIL file, and thus it is rather inconvenient to store, read, and transmit SMIL-related documents. If multimedia content written in SMIL, like the SMIL document shown in the box above, includes 100 picture files stored on a data storage medium, there is a need to store, manage, and transmit a total of 101 files, including an SMIL file and 100 picture files, which is very inconvenient.

### SUMMARY OF THE INVENTION

The present invention provides a method of managing multimedia content written in SMIL so that the multimedia content can be more effectively stored, reproduced, or transmitted, and a file system thereof.

According to an aspect of the present invention, there is provided a method of managing multimedia content created using synchronized multimedia integration language (SMIL). The method involves (a) extracting information on at least one resource file by parsing an SMIL document; and (b) packaging the SMIL document and the at least one resource file into a single file using the extracted information.

In an exemplary embodiment, (b) involves (b1) constituting a header; (b2) creating file indexing information that makes it possible to access the at least one resource file; and (b3) creating an SMIL integrated file by packaging the header, the file indexing information, the SMIL document, and the at least one resource file into a single file.

In an exemplary embodiment, in (b1), the header contains information on the number of files included in the SMIL integrated file and information on the length of the SMIL integrated file.

In an exemplary embodiment, in (b1), the header contains copyright information of at least one of the SMIL document and the at least one resource file.

In an exemplary embodiment, in (b2), the file indexing information contains the name, length, and offset information of each file included in the SMIL integrated file.

In an exemplary embodiment, the method further involves (c) storing the packaged SMIL integrated file.

In an exemplary embodiment, the method further involves (d) transmitting the packaged SMIL integrated file.

According to another aspect of the present invention, there is provided a method of managing multimedia content created using synchronized multimedia integration language (SMIL). The method involves (a) extracting information necessary for accessing files included in an SMIL integrated file by parsing the SMIL integrated file; (b) providing an SMIL document; and (c) providing a predetermined resource file by referring to the information extracted in (a) when a request for the predetermined resource file is issued.

In an exemplary embodiment, (a) involves extracting file indexing information that makes it possible to access the requested resource file, and (c) involves providing the requested resource file by referring to the file indexing information.

In an exemplary embodiment, (a) involves extracting the name, length, and offset information of each of the files included in the SMIL integrated file, and (c) involves searching for the requested resource file by referring to the extracted name, length, and offset information of each of the files included in the SMIL integrated file.

According to still another aspect of the present invention, there is provided a file system that manages multimedia content created using SMIL. The file system includes a parsing unit which extracts information on at least one resource file by parsing an SMIL document; and a packaging unit which packages the SMIL document and the at least one resource file into a single file using the extracted information.

In an exemplary embodiment, the packaging unit creates a header using the extracted information on the at least one resource file, creates file indexing information that makes it possible to access the at least one resource file; and creates an SMIL integrated file by packaging the header, the file indexing information, the SMIL document, and the at least one resource file into a single file.

In an exemplary embodiment, the packaging unit creates the header by inserting information on the number of files included in the SMIL integrated file and information on the length of the SMIL integrated file into the header.

In an exemplary embodiment, the packaging unit creates the header by inserting copyright information of at least one of the SMIL document and the at least one resource file into the header.

In an exemplary embodiment, the packaging unit packages the name, length, and offset information of each file included in the SMIL integrated file as the file indexing information.

In an exemplary embodiment, the file system further includes a file managing unit which stores or transmits the SMIL integrated file packaged by the packaging unit.

In an exemplary embodiment, the file system further includes a file managing unit which provides an SMIL document when there is a request for the predetermined SMIL document and provides a resource file linked to the SMIL document when there is a request for the resource file by referring to information, extracted from the SMIL integrated file by the parsing unit. In this case, the parsing unit extracts the information necessary for accessing files included in the SMIL integrated file by parsing the SMIL integrated file.

In an exemplary embodiment, the parsing unit extracts file indexing information that makes it possible to access the requested resource file, and the file managing unit searches for the requested resource file by referring to the file indexing information and provides the searched resource file.

In an exemplary embodiment, the parsing unit extracts file indexing information, including the name, length, and offset information of each of the files included in the SMIL integrated file, and the file managing unit searches for the requested resource file by referring to the extracted name, length, and offset information of each of the files included in the SMIL integrated file and provides the searched resource file.

### BRIEF DESCRIPTION OF THE DRAWINGS

The above and other features and advantages of the present invention will become more apparent by describing in detail exemplary embodiments thereof with reference to the attached drawings in which:

FIGS. 1A and 1B are block diagrams of an SMIL apparatus in which a file system according to an exemplary embodiment of the present invention is installed;

FIGS. 2 and 3 are a perspective view and a plan view, respectively, of examples of devices in which a file system according to an exemplary embodiment of the present invention is installed; and

FIG. 4 is a diagram illustrating elements of an SMIL integrated file according to an exemplary embodiment of the present invention;

FIG. 5 is a diagram illustrating the format of an SMIL integrated file according to an exemplary embodiment of the present invention;

FIG. 6 is a detailed diagram illustrating the structure of a header of FIG. 5;

FIG. 7 is a diagram illustrating file indexing information and a file block of FIG. 5 and the relationship therebetween;

FIG. 8 is a diagram illustrating an example of the SMIL integrated file of FIG. 5;

FIG. 9 is a flowchart of a method of managing multimedia content written in SMIL according to an exemplary embodiment of the present invention; and

FIG. 10 is a flowchart of a method of managing multimedia content written in SMIL according to another exemplary embodiment of the present invention.

### DETAILED DESCRIPTION OF THE INVENTION

Hereinafter, the present invention will be described more fully with reference to the accompanying drawings in which exemplary embodiments of the invention are shown.

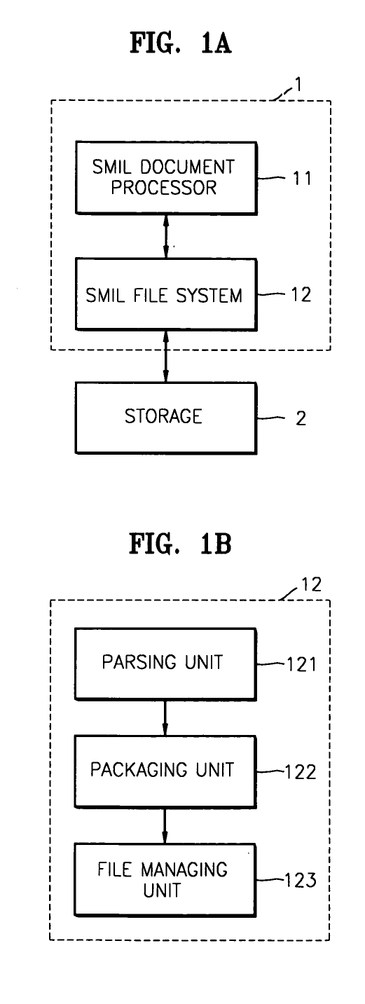

FIGS. 1A and 1B are block diagrams of a synchronized multimedia integration language (SMIL) apparatus in which a file system according to an exemplary embodiment of the present invention is installed.

Referring to FIG. 1A, an SMIL apparatus 1 includes an SMIL document processor 11 and an SMIL file system 12. The SMIL document processor 11 reproduces an SMIL document written in SMIL. In other words, the SMIL document processor 11 includes an execution engine that interprets and executes an SMIL document and a decoder that reproduces resource files, i.e., media objects linked to the SMIL document. The SMIL document processor 11 issues a request for necessary resource files to the SMIL file system 12 after interpreting the SMIL document and reproduces the corresponding resource files handed over thereto by the SMIL file system 12.

The SMIL file system 12 packages the SMIL document and the resource file into a single file. Furthermore, the SMIL file system 12 transmits the packaged file to an external device or stores the packaged file in a storage 2. Therefore, when a request for predetermined resource files is issued by the SMIL document processor 11, the SMIL file system 12 searches the storage 2 for the predetermined resource files and hands the predetermined resource files over to the SMIL document processor 11.

Referring to FIG. 1B, the SMIL file system 12 includes a parsing unit 121, a packaging unit 122, and a file managing unit 123. In order to generate an SMIL integrated file through packaging according to an exemplary embodiment of the present invention, the parsing unit 121 extracts information on at least one resource file by parsing an SMIL document. The packaging unit 122 packages the SMIL document and the resource files into a single file using the information extracted by the parsing unit 121. During this packaging process, a header and file indexing information that makes it possible to access the resource files are created using the extracted information on the resource file, and the header, the file indexing information, the SMIL document, and the resource files are packaged into an SMIL integrated file. For example, the header can be constituted by pieces of information, such as the number of files to be packaged into the SMIL integrated file and the length of the SMIL integrated file. Furthermore, copyright information on at least one of the SMIL document and the resource file can be contained in the header. The file managing unit 123 stores the SMIL integrated file provided by the packaging unit 122 in the storage 2 or transmits the corresponding SMIL integrated file to an external device.

In addition, the file managing unit 123 receives an SMIL integrated file from the outside and stores the received SMIL integrated file in the storage 2. The parsing unit 121 extracts information necessary to access files integrated in the received SMIL integrated file by parsing the received SMIL integrated file. Thereafter, the parsing unit 121 provides the extracted information to the file managing unit 123. More specifically, the parsing unit 121 extracts file indexing information that makes it possible to access resource files and provides the extracted file indexing information to the file managing unit 123. When the SMIL document processor 11 issues a request for predetermined resource files, the file managing unit 123 searches the storage 2 for the predetermined resource files by referring to the file indexing information provided by the parsing unit 121 and provides the searched resource file to the SMIL document processor 11.

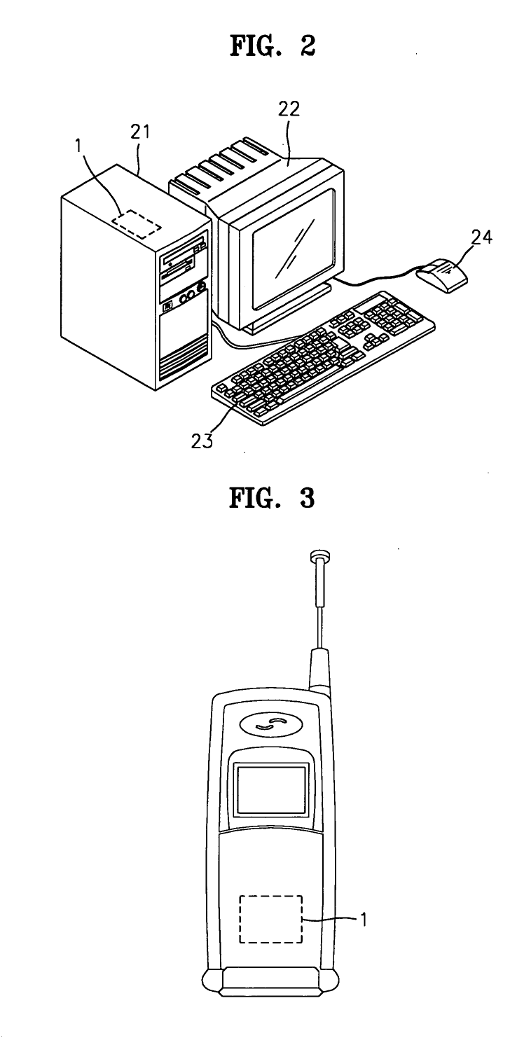

FIGS. 2 and 3 are a perspective view and a plan view, respectively, of examples of devices in which the file system 1 of FIG. 1A is installed. Referring to FIG. 2, the file system 1 is installed in a computer system. The computer system includes a main body 21, a display monitor 22, a keyboard 23, and a mouse 24. The file system 1 of FIG. 1A is installed in the main body 21. A hard disk (not shown) and memory (not shown) included in the main body 21 correspond to the storage 2 of FIG. 1.

Referring to FIG. 3, the file system 1 is installed in a mobile phone. Memory (not shown) installed in the mobile phone corresponds to the storage 2 of FIG. 1.

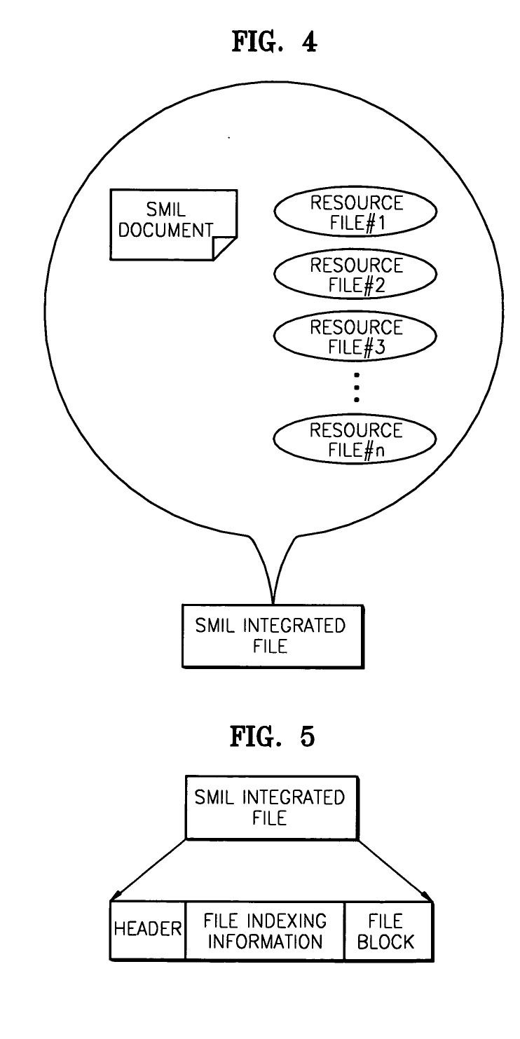

FIG. 4 is a diagram illustrating elements of an SMIL integrated file according to an exemplary embodiment of the present invention. Referring to FIG. 4, the SMIL integrated file is obtained by packaging an SMIL document and at least one resource file #1, #2, #3, . . . , #n into a single file. In other words, the SMIL integrated file contains the SMIL document and the at least one resource file 1, #2, #3, . . . , #n.

FIG. 5 is a diagram illustrating the format of an SMIL integrated file according to an exemplary embodiment of the present invention. Referring to FIG. 5, the SMIL integrated file is comprised of a header, file indexing information, and a file block. The header contains brief information on the SMIL integrated file and other pieces of information. The file indexing information is information necessary to search the file block, which is located right next to the file indexing information, for desired resource files. The file block contains an SMIL information and at least one resource file.

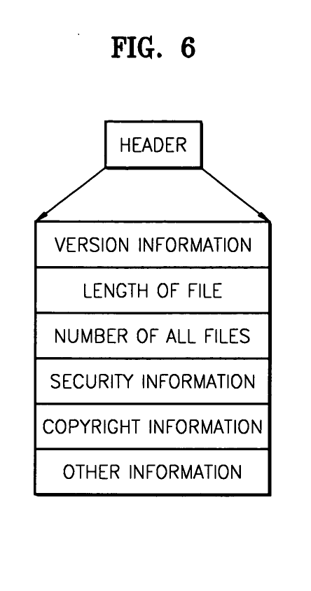

FIG. 6 is a diagram illustrating the structure of the header of FIG. 5. Referring to FIG. 6, the header contains version information, the total length of an SMIL integrated file, the number of files (including SMIL and resource files) packaged into the SMIL integrated file, security information, copyright information, and other information. The version information indicates the version of a File system. For example, the version information can be represented by SFS 1.0 meaning that the version of the SMIL file system is 1.0. The security information is, for example, encryption key information for security of at least part of the SMIL integrated file. The security information can be used to encrypt an SMIL document or a predetermined resource file. The copyright information represents information on the copyrights of the SMIL file or resource files. The copyright information may include the writer, date-of-writing, copyright protection period, and copying-allowable scope of a corresponding file. Other information contained in the header may include access restriction information indicating that access to at least part of the SMIL integrated file is restricted. For example, the SMIL integrated file can be allowed or restricted to be accessed by a person or a group of people, depending on their age, nationality, and language as well as their computer's operating system. Furthermore, a variety of information, such as comment information, can be contained in the header as other information.

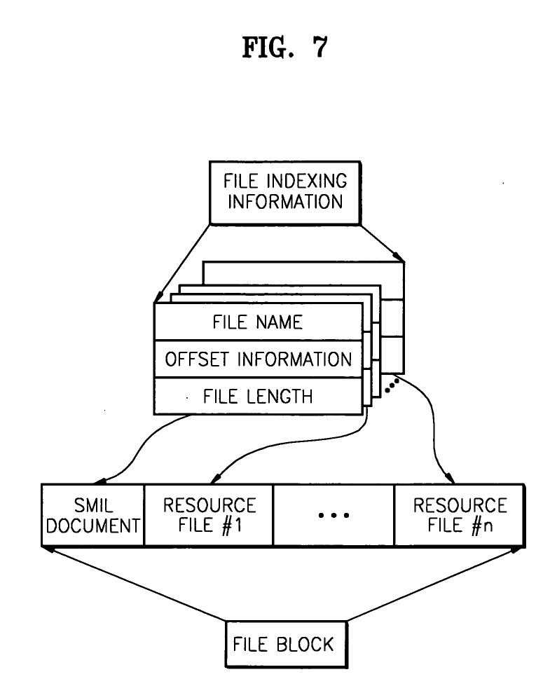

FIG. 7 is a diagram illustrating the file indexing information and file block of FIG. 5 and the relationship therebetween. Referring to FIG. 7, the file indexing information is comprised of as many pieces of unit information as there are files in the file block. In other words, since the file block includes a total of n+1 files, i.e., one SMIL document and n resource files #1, #2, #3, . . . , #n, n+1 file indexes are provided. Each of the file indexes contains the name, length, and offset information of a corresponding file. Here, the offset information indicates a starting point of the corresponding file.

In the prior art, headers are included in resource files. In the present embodiment, however, the SMIL document and the resource files #1, #2, . . . , #n are integrated into the SMIL integrated file. Thus, the headers are removed, and only net media content to be reproduced remains in the SMIL integrated file. Here, net file data represents net data necessary to interpret and execute SMIL documents.

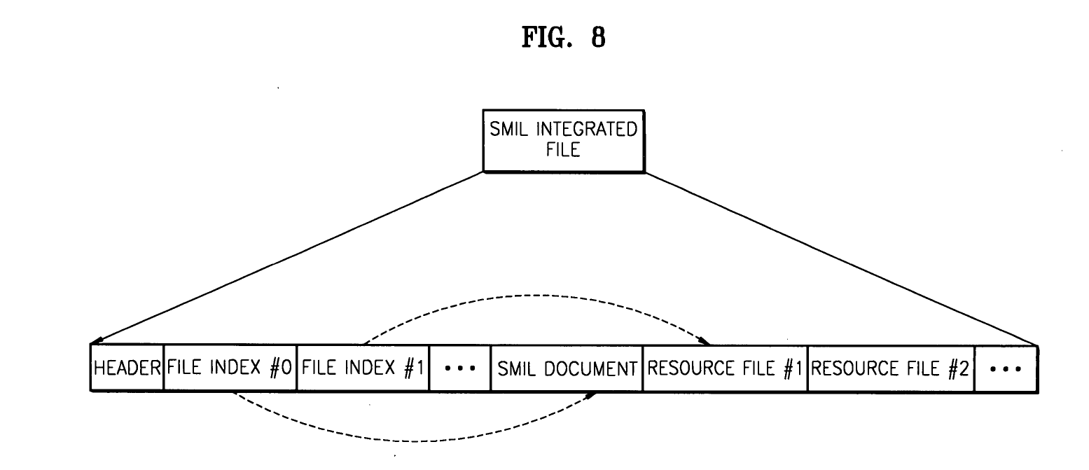

FIG. 8 is a diagram illustrating an example of the SMIL integrated file of FIG. 5. Referring to FIG. 8, in an SMIL integrated file, a header, file indexes #0, #1, #2, . . . , and a plurality of files, i.e., an SMIL document and resource files #1, #2, . . . , are sequentially arranged. Here, file index #0 corresponds to the SMIL document, file index #1 corresponds to resource file #1, and file index #2 corresponds to resource file #2.

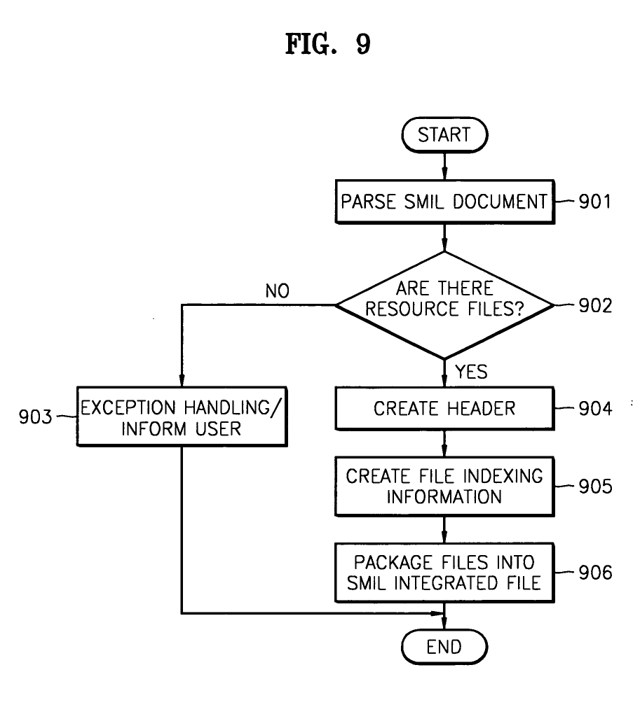

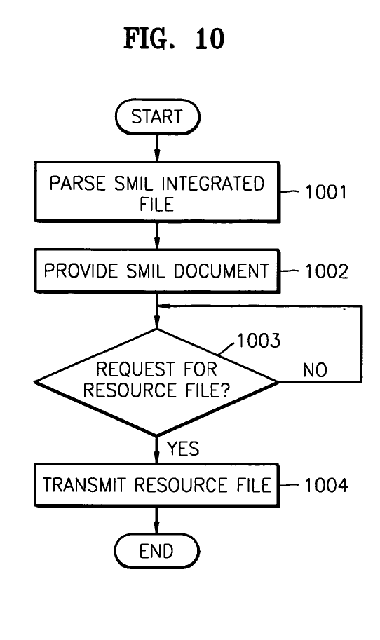

Hereinafter, a method of managing multimedia content, created using SMIL, using the SMIL file system 12 according to the present invention will be described in greater detail with reference to FIGS. 9 and 10.

FIG. 9 is a flowchart of a method of managing multimedia content created using SMIL according to an exemplary embodiment of the present invention. Referring to FIG. 9, in step 901, the SMIL file system 12 parses an SMIL document. In step 902, the SMIL file system 12 checks if there are resource files linked to the SMIL document by parsing the SMIL document. In step 903, if no resource file is linked to the SMIL document, the SMIL document is treated as an exception or a user is informed of the fact that no resource file is linked to the SMIL document. Then, the process ends. Otherwise, a header is created in step 904, file indexing information is created in step 905, and the header, the file indexing information, and the SMIL document, and resource files corresponding to the SMIL document are packaged into an SMIL integrated file in step 906. The structure of the header, the file indexing information, and the SMIL integrated file has already been described above. The SMIL integrated file is stored in the storage 2 or is transmitted to the outside.

FIG. 10 is a flowchart of a method of managing multimedia content created using SMIL according to another exemplary embodiment of the present invention. Referring to FIG. 10, in step 1001, the SMIL file system 12 extracts a header and header indexing information from an SMIL integrated file by parsing the SMIL integrated file. In step 1002, the SMIL file system 12 provides an SMIL document extracted from the SMIL integrated file to the SMIL document processor 11 when there is a request for the SMIL document. When the SMIL document processor 11 issues a request for a predetermined resource file in step 1003, the SMIL file system 12 reads the predetermined resource file by referring to the file indexing information extracted in step 1001 and then transfers the predetermined resource file to the SMIL document processor 11 in step 1004.

As described above, according to the present invention, it is possible to more effectively store, reproduce, or transmit multimedia content created using SMIL. In other words, an SMIL document and media objects that used to be stored in different files are integrated into a single file and the single file is managed and stored, which is even more convenient than in the prior art. For example, in order to transmit multimedia content in the prior art, a user has to search for resource files linked to an SMIL document by himself/herself, and then transmit the SMIL document and the resource files separately. On the contrary, in the present invention, there is no need to transmit a considerable number of files separately because a plurality of files to be transmitted is integrated into a single file. In addition, by storing various information, such as copyright information, security information, and access restriction information, in a header of an SMIL integrated file, it is possible to more efficiently protect the SMIL integrated file and its copyright and more successfully control attempts to access the SMIL integrated file.

1. A method of managing multimedia content created using synchronized multimedia integration language (SMIL), the method comprising:
extracting information on at least one resource file by parsing an SMIL document; and
packaging a plurality of files comprising the SMIL document and the at least one resource file into a single file using the extracted information.

2. The method of claim 1, wherein the operation of packaging comprises:
forming a header;
creating file indexing information to access the at least one resource file; and
creating an SMIL integrated file by packaging the header, the file indexing information, the SMIL document, and the at least one resource file into a single file.

3. The method of claim 2, wherein the header comprises information on the number of the plurality of files included in the SMIL integrated file and information on a length of the SMIL integrated file.

4. The method of claim 2, wherein the header comprises copyright information of at least one of the SMIL document and the at least one resource file.

5. The method of claim 2, wherein the file indexing information comprises respective name, length, and offset information of each of the plurality of files included in the SMIL integrated file.

6. The method of claim 1 further comprising:
storing a packaged SMIL integrated file.

7. The method of claim 1 further comprising:
transmitting a packaged SMIL integrated file.

8. A method of managing multimedia content created using synchronized multimedia integration language (SMIL), the method comprising:
extracting information for accessing a plurality of files included in an SMIL integrated file by parsing the SMIL integrated file;
providing an SMIL document; and
providing a predetermined resource file by referring to the information when a request for the predetermined resource file is issued.

9. The method of claim 8, wherein the operation of extracting the information comprises extracting file indexing information to access the predetermined resource file, and the operation of providing the predetermined resource file comprises providing the predetermined resource file by referring to the file indexing information.

10. The method of claim 8, wherein the operation of extracting the information comprises extracting respective name, length, and offset information of each of the plurality of files included in the SMIL integrated file, and the operation of providing the predetermined resource file comprises searching for the predetermined resource file by referring to the respective name, length, and offset information of each of the plurality of files included in the SMIL integrated file.

11. A file system that manages multimedia content created using synchronized multimedia integration language (SMIL), the file system comprising:
a parsing unit which extracts information on at least one resource file by parsing an SMIL document to generate extracted information; and
a packaging unit which packages a plurality of files including the SMIL document and the at least one resource file into a single file using the extracted information.

12. The file system of claim 11, wherein the packaging unit creates a header using the extracted information on the at least one resource file, creates file indexing information to access the at least one resource file; and
creates an SMIL integrated file by packaging the header, the file indexing information, the SMIL document, and the at least one resource file into a single file.

13. The file system of claim 12, wherein the packaging unit creates the header by inserting information on the number of the plurality of files included in the SMIL integrated file and information on a length of the SMIL integrated file into the header.

14. The file system of claim 11, wherein the packaging unit creates a header by inserting copyright information of at least one of the SMIL document and the at least one resource file.

15. The file system of claim 12, wherein the packaging unit packages respective name, length, and offset information of each of the plurality of files included in the SMIL integrated file as the file indexing information.

16. The file system of claim 111 further comprising:
a file managing unit which stores or transmits an SMIL integrated file packaged by the packaging unit.

17. The file system of claim 11 further comprising:
a file managing unit which provides a predetermined SMIL document when there is a request for the predetermined SMIL document and provides a predetermined resource file linked to the SMIL document when there is a request for the predetermined resource file by referring to corresponding information extracted from an SMIL integrated file by the parsing unit,
wherein the parsing unit extracts the corresponding information for accessing files included in the SMIL integrated file by parsing the SMIL integrated file.

18. The file system of claim 17, wherein the parsing unit extracts file indexing information to access the predetermined resource file, and the file managing unit searches for the predetermined resource file by referring to the file indexing information and provides the predetermined resource file.

19. The file system of claim 17, wherein the parsing unit extracts file indexing information, including respective name, length, and offset information of at least each of the plurality of files included in the SMIL integrated file, and the file managing unit searches for the predetermined resource file by referring to the name, length, and offset information of each of the plurality of files included in the SMIL integrated file and provides the predetermined resource file.
